(19) United States
(12) Patent Application Publication
(10) Pub. No.: US 2016/0345611 A1
(43) Pub. Date: Dec. 1, 2016

(54) RICE PROTEIN HYDROLYSATE BASED FORMULAS AND PRODUCTION THEREOF

(71) Applicant: Mead Johnson Nutrition Company, Glenview, IL (US)

(72) Inventors: Juan M. Gonzalez, Newburgh, IN (US); John D. Alvey, Evansville, IN (US); Zihua Ao, Newburgh, IN (US); Cristine Bradley, Ottawa (CA); Robert Cleveland, Buffalo Grove, IL (US); Jennifer Kinnaman, Newburgh, IN (US)

(21) Appl. No.: 14/723,501

(22) Filed: May 28, 2015

(51) Int. Cl. A23L 1/305; A23J 3/34; A23L 1/29; A23L 1/30

(52) U.S. Cl. CPC A23L 1/3053; A23L 1/30; A23J 3/346; A23L 1/296; A23L 1/3051; A23V 2002/00

(57) ABSTRACT

The present disclosure relates to nutritional composition(s) containing a protein equivalent source which includes a rice protein hydrolysate, and an octenyl succinic anhydride (OSA) modified starch emulsifier. The disclosure also relates to method(s) of producing rice protein hydrolysate, the method(s) including suspending rice protein in a solution to form a suspension; heating the suspension; cooling the heated suspension; adding an endoprotease to the suspension to hydrolyze the rice protein into at least two supernatant fractions; inactivating the endoprotease; separating an insoluble portion of the suspension from the at least two supernatant fractions; collecting the at least two supernatant fractions; and combining the at least two supernatant fractions.

### TECHNICAL FIELD

The present disclosure relates generally to nutritional compositions comprising rice protein hydrolysate and octenyl succinic anhydride modified starch. In some embodiments, the rice protein hydrolysate may be supplemented with free amino acids. In further embodiments, the rice protein hydrolysate contains a large proportion of small peptides and a small proportion of free amino acids. The nutritional compositions disclosed herein may be suitable for administration to pediatric subjects.

Additionally, the disclosure relates to methods of producing a rice protein hydrolysate that include the use of an endoprotease to hydrolyze rice protein. In an embodiment, a single endoprotease is added to the suspension to hydrolyze the rice protein into at least two supernatant fractions. Further, in some embodiments, the degree of hydrolysis of the rice protein may be from 10% to 35%. The method of producing rice protein hydrolysate may produce rice protein hydrolysate for administration to pediatric subjects in nutritional compositions.

### BACKGROUND OF THE INVENTION

Protein is a key component of many nutritional compositions. Commonly used sources of protein in nutritional products include dairy and soy. Rice protein and rice protein hydrolysates are alternative protein sources for nutritional products, particularly for subjects suffering from dairy or soy allergies. However, existing rice protein hydrolysates have been of insufficient nutritional quality to be a complete protein source for nutritional products. For example, many previous rice protein based protein sources are lacking in essential amino acids. Therefore, a need exists for a readily available rice protein hydrolysate that is a complete protein source for nutritional products.

The nutritional value of a protein hydrolysate is affected by its amino acid composition and its ability to be digested, absorbed and utilized in a subject's body. Inadequate bioavailability of amino acids in a nutritional composition resulting from poor protein quality may result in adversely affected growth and development for a subject.

Conventionally, rice protein has not been a good source of protein for nutritional compositions, especially infant nutritional compositions. Proteins may be classified into four types based on their respective solubility: albumin, which is water soluble; globulin, which is salt soluble; prolamin, which is alcohol soluble and glutelin, which is alkali or acid soluble. With respect to rice protein, the ratio of these classifications of proteins may vary with rice variety and extraction technique. For example, an average ratio for albumin:globulin:prolamin:glutelin in rice protein may be 5:9:3:83. Thus, traditionally, over 80% of rice protein, i.e., glutelin protein, may not be soluble at neutral pH, a typical pH for nutritional compositions. An insoluble protein in a nutritional composition may result in the composition's poor digestibility and undesirable physical properties, such as poor mixability, poor mouthfeel and tendency to plug an aperture, such as the nipple of a bottle. Thus, protein solubility in an about neutral pH nutritional composition is generally preferable in reconstitutable infant nutritional compositions. Accordingly, a need exists for a high quality rice protein with solubility at a neutral pH.

Provided herein are nutritional compositions comprising a rice protein hydrolysate and an octenyl succinic anhydride modified starch. The nutritional composition may be supplemented with free amino acids. Further, provided herein is a method of producing a rice protein hydrolysate.

### BRIEF SUMMARY OF THE INVENTION

Briefly, the present disclosure is directed, in an embodiment, to a nutritional composition that includes i) a protein equivalent source comprising a rice protein hydrolysate, ii) a carbohydrate, iii) a fat or lipid, and iv) an emulsifier including an octenyl succinic anhydride modified starch. In one embodiment, the rice protein hydrolysate has a molecular weight distribution such that from about 20% to about 35% has a molecular weight from 1000 to 1999 Daltons and about 1% to about 8% has a molecular weight from 2000 to 2999.

In an embodiment, the rice protein hydrolysate has a degree of hydrolysis in the range of from about 10% to about 35%.

In another embodiment, the octenyl succinic anhydride modified starch is from about 0.01% to about 20% by weight of the nutritional composition. In a further embodiment, the octenyl succinic anhydride modified starch is derived from a source having greater than about 95% amylopectin by weight.

In yet another embodiment, the protein equivalent source comprises at least one free amino acid. The at least one free amino acid may be selected from the group consisting of lysine, threonine, methionine, tryptophan, and combinations thereof. When present, each free amino acid may have a ratio of free amino acid to rice protein hydrolysate nitrogen content in a range of from about 0.5 g to 5 g of free amino acid per 16 g of nitrogen in the rice protein hydrolysate. In some embodiments, when lysine is present in the protein equivalent source, the ratio of lysine to nitrogen content of the rice protein hydrolysate may be a range of 0.5-5 g lysine per 16 g hydrolysate nitrogen; when threonine is present, the ratio of threonine to hydrolysate nitrogen can be 0.5-2 g threonine per 16 g hydrolysate nitrogen; for methionine, when present, the ratio can be 0.5-2 g methionine per 16 g hydrolysate nitrogen; and for tryptophan, the ratio can be 0.1-1.5 g tryptophan per 16 g hydrolysate nitrogen.

In still another embodiment, the nutritional composition includes at least one long chain polyunsaturated fatty acid. The at least one long chain polyunsaturated fatty acid may be docosahexaenoic acid, arachidonic acid, or a combination thereof.

In an embodiment, the nutritional composition includes at least one probiotic. The at least one probiotic may be Lactobacillus rhamnosus GG.

In yet another embodiment, the nutritional composition includes at least one prebiotic. The at least one prebiotic may include, for example, polydextrose and/or a galactooligosaccharide.

In an embodiment, the nutritional composition is supplemented with the free amino acids lysine, threonine, methionine, and tryptophan and comprises 0.01% to 20% octenyl succinic anhydride modified starch, at least one probiotic, at least one prebiotic, and at least one long chain polyunsaturated fatty acid.

Additionally, the disclosure is directed to methods of producing a rice protein hydrolysate. In an embodiment, at least two supernatant fractions are used as a protein source in the preparation of a nutritional formulation. In a further embodiment, only one endoprotease may be added to the suspension.

In another embodiment, the method of producing rice protein hydrolysate includes purifying the supernatant fractions. In one embodiment, the purification includes ultrafiltration.

In an embodiment, the method of producing rice protein hydrolysate includes drying the at least two supernatant fractions.

In a further embodiment, the method of producing rice protein hydrolysate includes adding an exoprotease. In another embodiment, the method of producing rice protein hydrolysate includes adding a peptidase. In a further embodiment, the endoprotease is bacillolysins or subtilysins obtained from Bacillus subtilis or Bacillus amyloliquefaciens.

It is to be understood that both the foregoing general description and the following detailed description present embodiments of the disclosure and are intended to provide an overview or framework for understanding the nature and character of the disclosure as it is claimed. The description serves to explain the principles and operations of the claimed subject matter. Other and further features and advantages of the present disclosure will be readily apparent to those skilled in the art upon a reading of the following disclosure.

### DETAILED DESCRIPTION OF THE INVENTION

Reference now will be made in detail to the embodiments of the present disclosure, one or more examples of which are set forth hereinbelow. Each example is provided by way of explanation of the nutritional composition of the present disclosure and is not a limitation. In fact, it will be apparent to those skilled in the art that various modifications and variations can be made to the teachings of the present disclosure without departing from the scope of the disclosure. For instance, features illustrated or described as part of one embodiment, can be used with another embodiment to yield a still further embodiment.

Thus, it is intended that the present disclosure covers such modifications and variations as come within the scope of the appended claims and their equivalents. Other objects, features and aspects of the present disclosure are disclosed in or are apparent from the following detailed description. It is to be understood by one of ordinary skill in the art that the present discussion is a description of exemplary embodiments only and is not intended as limiting the broader aspects of the present disclosure.

As used herein, the term “about” should be construed to refer to both of the numbers specified as the endpoint(s) of any range. Any reference to a range should be considered as providing support for any subset within that range.

“Nutritional composition” means a substance or formulation that satisfies at least a portion of a subject's nutrient requirements. The terms “nutritional(s)”, “nutritional formula(s)”, “enteral nutritional(s)”, and “nutritional supplement(s)” are used as non-limiting examples of nutritional composition(s) throughout the present disclosure. Moreover, “nutritional composition(s)” may refer to liquids, powders, gels, pastes, solids, tablets, concentrates, suspensions, or ready-to-use forms of enteral formulas, oral formulas, formulas for infants, formulas for pediatric subjects, formulas for children, growing-up milks and/or formulas for adults.

“Pediatric subject” means a human less than 13 years of age. In some embodiments, a pediatric subject refers to a human subject that is between birth and 8 years old. In other embodiments, a pediatric subject refers to a human subject between 1 and 6 years of age. In still further embodiments, a pediatric subject refers to a human subject between 6 and 12 years of age. The term “pediatric subject” may refer to infants (preterm or full term) and/or children, as described below.

“Infant” means a human subject ranging in age from birth to not more than one year and includes infants from 0 to 12 months corrected age. The phrase “corrected age” means an infant's chronological age minus the amount of time that the infant was born premature. Therefore, the corrected age is the age of the infant if it had been carried to full term. The term infant includes low birth weight infants, very low birth weight infants, and preterm infants. “Preterm” means an infant born before the end of the 37th week of gestation. “Full term” means an infant born after the end of the 37th week of gestation.

“Child” means a subject ranging in age from 12 months to about 13 years. In some embodiments, a child is a subject between the ages of 1 and 12 years old. In other embodiments, the terms “children” or “child” refer to subjects that are between one and about six years old, or between about seven and about 12 years old. In other embodiments, the terms “children” or “child” refer to any range of ages between 12 months and about 13 years.

“Infant formula” means a composition that satisfies at least a portion of the nutrient requirements of an infant. In the United States, the content of an infant formula is dictated by the federal regulations set forth at 21 C.F.R. Sections 100, 106, and 107. These regulations define macronutrient, vitamin, mineral, and other ingredient levels in an effort to simulate the nutritional and other properties of human breast milk.

The term “growing-up milk” refers to a broad category of nutritional compositions intended to be used as a part of a diverse diet in order to support the normal growth and development of a child between the ages of about 1 and about 6 years of age.

“Nutritionally complete” means a composition that may be used as the sole source of nutrition, which would supply essentially all of the required daily amounts of vitamins, minerals, and/or trace elements in combination with proteins, carbohydrates, and lipids. Indeed, “nutritionally complete” describes a nutritional composition that provides adequate amounts of carbohydrates, lipids, essential fatty acids, proteins, essential amino acids, conditionally essential amino acids, vitamins, minerals and energy required to support normal growth and development of a subject.

A nutritional composition that is “nutritionally complete” for a full term infant will, by definition, provide qualitatively and quantitatively adequate amounts of all carbohydrates, lipids, essential fatty acids, proteins, essential amino acids, conditionally essential amino acids, vitamins, minerals, and energy required for growth of the full term infant. In certain embodiments, the disclosed nutritional composition is nutritionally complete for a full term infant.

Likewise, a nutritional composition that is “nutritionally complete” for a preterm infant will, by definition, provide qualitatively and quantitatively adequate amounts of carbohydrates, lipids, essential fatty acids, proteins, essential amino acids, conditionally essential amino acids, vitamins, minerals, and energy required for growth of the preterm infant. In certain embodiments, the disclosed nutritional composition is nutritionally complete for a preterm infant.

A nutritional composition that is “nutritionally complete” for a child will, by definition, provide qualitatively and quantitatively adequate amounts of all carbohydrates, lipids, essential fatty acids, proteins, essential amino acids, conditionally essential amino acids, vitamins, minerals, and energy required for growth of a child. In certain embodiments, the disclosed nutritional composition is nutritionally complete for a child.

The nutritional composition of the present disclosure may be substantially free of any optional or selected ingredients described herein, provided that the remaining nutritional composition still contains all of the required ingredients or features described herein. In this context, and unless otherwise specified, the term “substantially free” means that the selected composition may contain less than a functional amount of the optional ingredient, typically less than 0.1% by weight, and also, including zero percent by weight of such optional or selected ingredient.

As applied to nutrients, the term “essential” refers to any nutrient that cannot be synthesized by the body in amounts sufficient for normal growth and to maintain health and that, therefore, must be supplied by the diet. The term “conditionally essential” as applied to nutrients means that the nutrient must be supplied by the diet under conditions when adequate amounts of the precursor compound is unavailable to the body for endogenous synthesis to occur.

The term “degree of hydrolysis” refers to the extent to which peptide bonds are broken by a hydrolysis method. For example, the rice protein hydrolysate of the present disclosure may, in some embodiments comprise hydrolyzed rice protein having a degree of hydrolysis of 35%. For this example, this means that 35% of the total peptide bonds have been cleaved by a hydrolysis method. The degree of protein hydrolysis for purposes of characterizing the hydrolyzed protein component of the nutritional composition is easily determined by one of ordinary skill in the formulation arts by quantifying the amino nitrogen to total nitrogen ratio (AN/TN) of the protein component of the selected formulation. The amino nitrogen component is quantified by USP titration methods for determining amino nitrogen content, while the total nitrogen component is determined by the Kjeldahl method, which is a well-known method to one of ordinary skill in the analytical chemistry art. Generally, the degree of hydrolysis is the amount of amino nitrogen divided by the total nitrogen, expressed as a percentage.

The term “partially hydrolyzed” means having a degree of hydrolysis which is greater than 0% but less than 50%.

The term “extensively hydrolyzed” means having a degree of hydrolysis which is greater than or equal to 50%.

“Protein efficiency ratio” (PER) is a widely accepted method in the art for determining protein quality. Worldwide regulations, including those in the US, Mexico and Canada, specify protein quality requirements for infant formulas using methodology such as PER. The PER value in the present disclosure is calculated following the Official Methods of Analysis (AOAC) Official Method 960.48. Specifically, PER=(animal body weight gain (g))/(total diet intake (g)×percent of protein in diet). PER is a measure of bioavailability; bioavailability affects utilization in the human body, thus affecting human growth and development.

“Relative Per” is the PER as a percentage of the PER of casein, and is calculated as follows: PER of test diet×100/PER of Animal Nutritional Research Council (ANRC) casein.

The term “protein equivalent” as used herein includes functional equivalents of protein(s), which exert beneficial health effects on a target subject without containing any intact protein. For example, “protein equivalent” may include hydrolyzed protein, including partially hydrolyzed protein and extensively hydrolyzed protein, peptides and/or peptide fractions, amino acids, and combinations thereof.

The term “amino acids” comprises, but is not limited to, histidine, isoleucine, leucine, lysine, methionine, cysteine, phenylalanine, tyrosine, threonine, tryptophan, valine, alanine, arginine, asparagine, aspartic acid, glutamic acid, glutamine, glycine, proline, serine, carnitine, taurine and mixtures thereof. Amino acids may be branched chain amino acids.

Size exclusion chromatography (SEC) can be used to determine the molecular weight distribution of the rice protein hydrolysate of the present disclosure. For example, a sufficient amount of the powdered nutritional composition is weighed out to provide 0.5 g of protein into a 50 mL conical centrifuge tube. Water is added to bring the tube to a volume of 45 mL. The mixture is placed in a Sarstedt D-5223 Mixer and mixed for one hour. After mixing, a 1% protein solution is created by adding another 5 ml of water to the tube. A stock standard is prepared and mixed for one hour as well. Separately, 14.91 g potassium chloride (KCl) is added to a 1000 mL beaker. The KCl is dissolved by adding 700 mL of water to the beaker. 250 mL acetonitrile and 1.0 mL trifloroacetic acid is then added to the KCl solution (eluent). The pH is adjusted to 3.0 using a 0.2M K2HPO4 solution. An HPCL reagent bottle is filled and the bottle is washed with eluent, reserving about 50 mL for dilution of samples and standards. The Hitachi L-6200 A Intelligent Pump lines are purged with eluent and the columns are equilibrated with eluent for one hour. After the samples are mixed for about one hour, 5.0 mL of each sample is pipetted into glass screw-cap tubes. 5.0 mL Dichloromethane is also pipetted into each tube. The tubes are capped and mixed by inversion four times. The samples are then centrifuged for five minutes at 200×G. While the samples are in the centrifuge, the stock standards 1-5 are diluted with eluent (800 μL+3200 μL). Approximately 1 ml of each standard is pipetted into each of two autosampler vials and capped. The upper (aqueous) layer of the centrifuged samples 1-10 are diluted with eluent (100 μL+900 μL). The vials are loaded into the autosampler tray as follows: blank, standard, samples and second standard. The tray is placed in the Hitachi autosampler. The total number of vials to be run are entered into the autosampler program using the keys on the front of the autosampler and the samples are run. The results indicate the molecular weight profile of the rice protein hydrolysate.

“Probiotic” means a microorganism with low or no pathogenicity that exerts at least one beneficial effect on the health of the host. An example of a probiotic is Lactobacillus rhamnosus GG (“LGG”).

As used herein, the term “viable,” refers to live microorganisms. The term “non-viable” or “non-viable probiotic” means non-living probiotic microorganisms, their cellular components and/or metabolites thereof. Such non-viable probiotics may have been heat-killed or otherwise inactivated, but they retain the ability to favorably influence the health of the host. The probiotics useful in the present disclosure may be naturally-occurring, synthetic or developed through the genetic manipulation of organisms, whether such source is now known or later developed.

The term “inactivated probiotic” means a probiotic wherein the metabolic activity or reproductive ability of the referenced probiotic organism has been reduced or destroyed. The “inactivated probiotic” does, however, still retain, at the cellular level, at least a portion its biological glycol-protein and DNA/RNA structure. As used herein, the term “inactivated” is synonymous with “non-viable.” More specifically, a non-limiting example of an inactivated probiotic is inactivated Lactobacillus rhamnosus or “inactivated LGG.”

“Prebiotic” means a non-digestible food ingredient that beneficially affects the host by selectively stimulating the growth and/or activity of one or a limited number of bacteria in the digestive tract that can improve the health of the host. Examples of prebiotics include polydextrose (PDX) and galactooligosaccharides (GOS).

“β-glucan” means all β-glucan, including specific types of β-glucan, such as β-1,3-glucan or β-1,3;1,6-glucan. Moreover, β-1,3;1,6-glucan is a type of β-1,3-glucan. Therefore, the term “β-1,3-glucan” includes β-1,3;1,6-glucan.

All percentages, parts and ratios as used herein are by weight of the total composition, unless otherwise specified.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The methods and compositions of the present disclosure, including components thereof, can comprise, consist of, or consist essentially of the essential elements and limitations of the embodiments described herein, as well as any additional or optional ingredients, components or limitations described herein or otherwise useful in nutritional compositions.

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicant reserves the right to challenge the accuracy and pertinence of the cited references.

Although preferred embodiments of the disclosure have been described using specific terms, devices, and methods, such description is for illustrative purposes only. The words used are words of description rather than of limitation. It is to be understood that changes and variations may be made by those of ordinary skill in the art without departing from the spirit or the scope of the present disclosure, which is set forth in the following claims. In addition, it should be understood that aspects of the various embodiments may be interchanged either in whole or in part. Therefore, the spirit and scope of the appended claims should not be limited to the description of the preferred versions contained therein.

The present disclosure relates generally to nutritional compositions which comprise a protein equivalent source comprising a rice protein hydrolysate, with an octenyl succinic anhydride modified starch emulsifier. Further, the disclosure relates to a method of producing rice protein hydrolysate. The rice protein hydrolysate-based nutritional composition of the present disclosure has improved protein quality, leading to improved digestibility, solubility and physical properties. Improved protein quality may be illustrated by protein efficiency ratio (PER). In one embodiment, the PER may be at least about 1.6, preferably at least about 2.2. In another embodiment, the PER is in a range of from about 1.6 to about 2.9. In other embodiments, the relative PER of the composition of the disclosure is at least about 55%; more preferably, the relative PER is about 55% to about 100%.

In an embodiment, the rice protein hydrolysate has a degree of hydrolysis in the range of from about 10% to about 35%.

In an embodiment, the nutritional composition may comprise from about 10% to about 30% rice protein hydrolysate by weight, preferably from about 15% to about 25% by weight. In one embodiment, the nutritional composition comprises from about 16% to about 20% rice protein hydrolysate by weight.

In another embodiment, the molecular weight distribution of the rice protein hydrolysate is such that at least about 20% of the rice protein hydrolysate has a molecular weight of from 1000 to 1999 Daltons, and at least about 1% of the rice protein hydrolysate has a molecular weight distribution of from 2000 to 2999 Daltons. In still another embodiment, about 20% to about 35% of the rice protein hydrolysate has a molecular weight of from 1000 to 1999 Daltons and from about 1% to about 8% of the rice protein hydrolysate has a molecular weight of from 2000 to 2999.

In an embodiment, the rice protein hydrolysate has a molecular weight distribution of:

>5000 Daltons between about 1% and about 2%;

3000-4999 Daltons between about 1.5% and about 3%;

2000-2999 Daltons between about 4% and about 8%;

1000-1999 Daltons between about 20% and about 35%;

500-999 Daltons between about 40% and about 50%; and

<500 Daltons between about 15% and 20%.

In another embodiment, the rice protein hydrolysate has a molecular weight distribution of:

>5000 Daltons between about 1% and about 2%;

3000-4999 Daltons between about 2% and about 3%;

2000-2999 Daltons between about 5% and about 7%;

1000-1999 Daltons between about 25% and about 30%;

500-999 Daltons between about 42% and about 48%; and

<500 Daltons between about 16% and 19%.

In an embodiment, the protein equivalent source of the disclosed nutritional composition contains at least one free amino acid. The free amino acids may include any amino acid, including lysine, threonine, methionine and tryptophan. If lysine is present, the ratio of lysine content to nitrogen content of the rice protein hydrolysate may be in a range of about 0.5 g to about 5 g/16 g hydrolysate nitrogen. If threonine is present, the ratio of threonine content to nitrogen content of the rice protein hydrolysate may be in a range of about 0.5 g to about 2 g/16 g hydrolysate nitrogen. If methionine is present, the ratio of methionine content to nitrogen content of the rice protein hydrolysate may be in a range of about 0.5 g to about 2 g/16 g hydrolysate nitrogen. If tryptophan is present, the ratio of tryptophan content to nitrogen content of the rice protein hydrolysate may be in a range of about 0.1 g to about 1.5 g/16 g hydrolysate nitrogen. The combination of free amino acids in the protein equivalent source may include lysine and threonine; in another embodiment, lysine, threonine and methionine; in still another embodiment, lysine, threonine, methionine and tryptophan. The protein equivalent source may be free of intact proteins. In an embodiment, the protein equivalent source consists of the disclosed rice protein hydrolysate. In another embodiment, the protein equivalent source consists of the disclosed rice protein hydrolysate and free amino acids.

The nutritional composition also includes octenyl succinic anhydride (OSA) modified starch present at a level of from 0.01% to 20% by weight. The octenyl succinic anhydride modified starch may be derived from corn, rice, potato, tapioca, octenyl succinic anhydride modified maltodextrins, octenyl succinic anhydride modified syrup, and/or combinations thereof. The nutritional composition may contain octenyl succinic anhydride modified starch and other emulsifiers, such as lecithin, monoglycerides and diglycerides. In a further embodiment, octenyl succinic anhydride modified starch is the sole emulsifier. The weight of the emulsifier(s) in the nutritional composition may be within a range of from about 0.01% to about 20% by weight, preferably from about 2% to about 15% by weight, most preferably from about 3% to about 10% by weight. In an embodiment, the OSA modified starch is present at a starch to lipid ratio of between about 1:1 to about 1:8, preferably between about 1:5 to about 1:7.

In another embodiment, the nutritional composition may include octenyl succinic anhydride modified starch that is derived from a waxy starch with generally greater than about 95% amylopectin by weight. In an alternate embodiment, the octenyl succinic anhydride modified starch may be derived from any non-waxy starch.

While not wanting to be bound by any particular theory, octenyl succinic anhydride modified starch and a rice protein hydrolysate may create an acceptable hypoallergenic nutritional composition. The octenyl succinic anhydride modified starch acts as an emulsifier, preventing creaming or phase separation in nutritional compositions. Octenyl succinic anhydride modified starch may be superior over convention emulsifiers that have yellow to yellow-brown color characteristics of citric acid esters of conventional emulsifiers, such as monoglycerides, diglycerides and lecithin. Additionally, octenyl succinic anhydride modified starch obviates the need for soy lecithin as an emulsifier, avoiding the possible introduction of soy protein contaminants, potential allergens, into the nutritional composition.

The nutritional compositions of the present disclosure may optionally include additional emulsifiers that may be added for stability of the final product. Examples of suitable emulsifiers include, but are not limited to, lecithin (e.g., from egg or soy), alpha lactalbumin, octenyl succinic anhydride modified starch, and/or mono- and di-glycerides and mixtures thereof. Other emulsifiers are readily apparent to the skilled artisan and selection of suitable emulsifier(s) will depend, in part, upon the formulation and final product. In one embodiment, the nutritional composition contains solely one emulsifier—octenyl succinic anhydride modified starch and is free of other emulsifiers.

The nutritional composition(s) of the present disclosure may also comprise a carbohydrate. The carbohydrate can be any used in the art, e.g., hydrolyzed or intact, naturally or chemically modified, in waxy or non-waxy forms. For example, suitable carbohydrates may include lactose, glucose, glucose polymers, fructose, corn syrup solids, maltodextrins, sucrose, starch, rice syrup solids, hydrolyzed cornstarch, maltodextrin, maltose, dextrose, high fructose corn syrup, indigestible oligosaccharides, and carbohydrates sourced from corn, tapioca, rice and potato or a combination thereof. The amount of carbohydrate in the nutritional composition typically is at least about 5 g/100 kcal. In an embodiment, the carbohydrate is present in an amount of between about 5 g and about 25 g/100 kcal. In some embodiments, the amount of carbohydrate is between about 6 g and about 22 g/100 kcal. In other embodiments, the amount of carbohydrate is between about 12 g and about 14 g/100 kcal. In some embodiments, corn syrup solids are preferred. Moreover, hydrolyzed, partially hydrolyzed, and/or extensively hydrolyzed carbohydrates may be desirable for inclusion in the nutritional composition due to their easy digestibility.

Suitable fats or lipids for use in the nutritional composition of the present disclosure may be any known or used in the art, including but not limited to, animal sources, e.g., milk fat, butter, butter fat, egg yolk lipid; marine sources, such as fish oils, marine oils, single cell oils; vegetable and plant oils, such as corn oil, canola oil, sunflower oil, soybean oil, palmolein, coconut oil, high oleic sunflower oil, evening primrose oil, rapeseed oil, olive oil, flaxseed (linseed) oil, cottonseed oil, high oleic safflower oil, palm stearin, palm kernel oil, wheat germ oil; medium chain triglyceride oils and emulsions and esters of fatty acids; and any combinations thereof.

The lipids or fats can be included in the nutritional composition at a level of no greater than about 7 g/100 kcal; in an embodiment, the amount of lipids or fats typically can vary from about 2 to about 7 g/100 kcal.

In some embodiments the nutritional composition may include an enriched lipid fraction derived from milk. The enriched lipid fraction derived from milk may be produced by any number of fractionation techniques. These techniques include but are not limited to melting point fractionation, organic solvent fractionation, super critical fluid fractionation, and any variants and combinations thereof. In some embodiments the nutritional composition may include an enriched lipid fraction derived from milk that contains milk fat globules.

In certain embodiments, the addition of the enriched lipid fraction or the enriched lipid fraction including milk fat globules may provide a source of saturated fatty acids, trans-fatty acids, monounsaturated fatty acids, polyunsaturated fatty acids, branched chain fatty acids, conjugated lipolenic, cholesterol, phospholipids, and/or milk fat globule membrane proteins to the nutritional composition.

The milk fat globules may have an average diameter (volume-surface area average diameter) of at least about 2 μm. In some embodiments, the average diameter is in the range of from about 2 μm to about 13 μm. In other embodiments, the milk fat globules may range from about 2.5 μm to about 10 μm. Still in other embodiments, the milk fat globules may range in average diameter from about 3 μm to about 6 μm. The specific surface area of the globules is, in certain embodiments, less than 3.5 m²/g, and in other embodiments is between about 0.9 m²/g to about 3 m²/g. Without being bound by any particular theory, it is believed that milk fat globules of the aforementioned sizes are more accessible to lipases therefore leading to better digestion lipid digestion.

In some embodiments the nutritional composition comprises sialic acid. Sialic acids are a family of over 50 members of 9-carbon sugars, all of which are derivatives of neuroaminic acid. The predominant sialic acid family found in humans is from the N-acetylneuraminic acid sub-family. Sialic acids are found in milk, such as bovine and caprine. In mammals, neuronal cell membranes have the highest concentration of sialic acid compared to other body cell membranes. Sialic acid residues are also components of gangliosides.

If included in the nutritional composition, sialic acid may be present in an amount from about 0.5 mg/100 kcals to about 45 mg/100 kcal. In some embodiments sialic acid may be present in an amount from about 5 mg/100 kcal to about 30 mg/100 kcal. In still other embodiments, sialic acid may be present in an amount from about 10 mg/100 kcal to about 25 mg/100 kcal.

The nutritional composition of the disclosure also contains a source of LCPUFAs; especially a source of LCPUFAs that comprises docosahexaenoic acid (DHA). Other suitable LCPUFAs include, but are not limited to, α-linoleic acid, γ-linoleic acid, linoleic acid, linolenic acid, eicosapentaenoic acid (EPA) and arachidonic acid (ARA).

In an embodiment, especially if the nutritional composition is an infant formula, the nutritional composition is supplemented with both DHA and ARA. In this embodiment, the weight ratio of ARA:DHA may be between about 1:3 and about 9:1. In a particular embodiment, the ratio of ARA:DHA is from about 1:2 to about 4:1.

The amount of long chain polyunsaturated fatty acid in the nutritional composition is advantageously at least about 5 mg/100 kcal, and may vary from about 5 mg/100 kcal to about 100 mg/100 kcal, more preferably from about 10 mg/100 kcal to about 50 mg/100 kcal.

The nutritional composition may be supplemented with oils containing DHA and/or ARA using standard techniques known in the art. For example, DHA and ARA may be added to the composition by replacing an equivalent amount of an oil, such as high oleic sunflower oil, normally present in the composition. As another example, the oils containing DHA and ARA may be added to the composition by replacing an equivalent amount of the rest of the overall fat blend normally present in the composition without DHA and ARA.

If utilized, the source of DHA and/or ARA may be any source known in the art such as marine oil, fish oil, single cell oil, egg yolk lipid, and brain lipid. In some embodiments, the DHA and ARA are sourced from single cell Martek oils, DHASCO® and ARASCO®, or variations thereof. The DHA and ARA can be in natural form, provided that the remainder of the LCPUFA source does not result in any substantial deleterious effect on the infant. Alternatively, the DHA and ARA can be used in refined form.

In an embodiment, sources of DHA and ARA are single cell oils as taught in U.S. Pat. Nos. 5,374,567; 5,550,156; and 5,397,591, the disclosures of which are incorporated herein in their entirety by reference. However, the present disclosure is not limited to only such oils.

In one embodiment, the nutritional composition may contain one or more probiotics. Any probiotic known in the art may be acceptable in this embodiment. In a particular embodiment, the probiotic may be selected from any Lactobacillus species, Lactobacillus rhamnosus GG (LGG) (ATCC number 53103), Bifidobacterium species, Bifidobacterium longum BB536 (BL999, ATCC: BAA-999), Bifidobacterium longum AH1206 (NCIMB: 41382), Bifidobacterium breve AH1205 (NCIMB: 41387), Bifidobacterium infantis 35624 (NCIMB: 41003), and Bifidobacterium animalis subsp. lactis BB-12 (DSM No. 10140) or any combination thereof.

If included in the composition, the amount of the probiotic may vary from about 1×10⁴ to about 1.5×10¹² cfu of probiotic(s) per 100 kcal. In some embodiments the amount of probiotic may be from about 1×10⁶ to about 1×10⁹ cfu of probiotic(s) per 100 kcal. In certain other embodiments the amount of probiotic may vary from about 1×10⁷ cfu/100 kcal to about 1×10⁸ cfu of probiotic(s) per 100 kcal.

In an embodiment, the probiotic(s) may be viable or non-viable. As used herein, the term “viable”, refers to live microorganisms. The term “non-viable” or “non-viable probiotic” means non-living probiotic microorganisms, their cellular components and/or metabolites thereof. Such non-viable probiotics may have been heat-killed or otherwise inactivated, but they retain the ability to favorably influence the health of the host. The probiotics useful in the present disclosure may be naturally-occurring, synthetic or developed through the genetic manipulation of organisms, whether such source is now known or later developed.

In some embodiments, the nutritional composition may include a source comprising probiotic cell equivalents, which refers to the level of non-viable, non-replicating probiotics equivalent to an equal number of viable cells. The term “non-replicating” is to be understood as the amount of non-replicating microorganisms obtained from the same amount of replicating bacteria (cfu/g), including inactivated probiotics, fragments of DNA, cell wall or cytoplasmic compounds. In other words, the quantity of non-living, non-replicating organisms is expressed in terms of cfu as if all the microorganisms were alive, regardless whether they are dead, non-replicating, inactivated, fragmented etc. In non-viable probiotics are included in the nutritional composition, the amount of the probiotic cell equivalents may vary from about 1×10⁴ to about 1.5×10¹⁰ cell equivalents of probiotic(s) per 100 kcal. In some embodiments the amount of probiotic cell equivalents may be from about 1×10⁶ to about 1×10⁹ cell equivalents of probiotic(s) per 100 kcal nutritional composition. In certain other embodiments the amount of probiotic cell equivalents may vary from about 1×10⁷ to about 1×10⁸ cell equivalents of probiotic(s) per 100 kcal of nutritional composition.

In some embodiments, the probiotic source incorporated into the nutritional composition may comprise both viable colony-forming units, and non-viable cell-equivalents.

In some embodiments, the nutritional composition includes a culture supernatant from a late-exponential growth phase of a probiotic batch-cultivation process. Without wishing to be bound by theory, it is believed that the activity of the culture supernatant can be attributed to the mixture of components (including proteinaceous materials, and possibly including (exo)polysaccharide materials) as found released into the culture medium at a late stage of the exponential (or “log”) phase of batch cultivation of the probiotic. The term “culture supernatant” as used herein, includes the mixture of components found in the culture medium. The stages recognized in batch cultivation of bacteria are known to the skilled person. These are the “lag,” the “log” (“logarithmic” or “exponential”), the “stationary” and the “death” (or “logarithmic decline”) phases. In all phases during which live bacteria are present, the bacteria metabolize nutrients from the media, and secrete (exert, release) materials into the culture medium. The composition of the secreted material at a given point in time of the growth stages is not generally predictable.

In an embodiment, a culture supernatant is obtainable by a process comprising the steps of (a) subjecting a probiotic such as LGG to cultivation in a suitable culture medium using a batch process; (b) harvesting the culture supernatant at a late exponential growth phase of the cultivation step, which phase is defined with reference to the second half of the time between the lag phase and the stationary phase of the batch-cultivation process; (c) optionally removing low molecular weight constituents from the supernatant so as to retain molecular weight constituents above 5-6 kiloDaltons (kDa); (d) removing liquid contents from the culture supernatant so as to obtain the composition.

The culture supernatant may comprise secreted materials that are harvested from a late exponential phase. The late exponential phase occurs in time after the mid exponential phase (which is halftime of the duration of the exponential phase, hence the reference to the late exponential phase as being the second half of the time between the lag phase and the stationary phase). In particular, the term “late exponential phase” is used herein with reference to the latter quarter portion of the time between the lag phase and the stationary phase of the LGG batch-cultivation process. In some embodiments, the culture supernatant is harvested at a point in time of 75% to 85% of the duration of the exponential phase, and may be harvested at about ⅚ of the time elapsed in the exponential phase.

The disclosed nutritional composition described herein can, in some embodiments, also comprise a prebiotic. Prebiotics useful in the present disclosure may include oligosaccharides, polysaccharides, and other prebiotics that contain fructose, xylose, soya, galactose, glucose and mannose.

Further useful prebiotics in the present disclosure may include polydextrose, polydextrose powder, lactulose, lactosucrose, raffinose, gluco-oligosaccharide, inulin, fructo-oligosaccharide, isomalto-oligosaccharide, soybean oligosaccharides, lactosucrose, xylo-oligosaccharide, chito-oligosaccharide, manno-oligosaccharide, aribino-oligosaccharide, siallyl-oligosaccharide, fuco-oligosaccharide, galacto-oligosaccharide, and gentio-oligosaccharides. In one embodiment, the prebiotic comprises galacto-oligosaccharide, polydextrose, or mixtures thereof.

In an embodiment, the amount of galacto-oligosaccharide in the nutritional composition may be from about 0.1 g/100 kcal to about 1.0 g/100 kcal. In another embodiment, the amount of galacto-oligosaccharide in the nutritional composition may be from about 0.1 g/100 kcal to about 0.5 g/100 kcal. The amount of polydextrose in the nutritional composition may, in an embodiment, be within the range of from about 0.1 g/100 kcal to about 0.5 g/100 kcal. In a particular embodiment, galacto-oligosaccharide and polydextrose are supplemented into the nutritional composition in a total amount of about at least about 0.2 g/100 kcal and can be about 0.2 g/100 kcal to about 1.5 g/100 kcal. In some embodiments, the nutritional composition may comprise galactooligosaccharide and polydextrose in a total amount of from about 0.6 g/100 kcal to about 0.8 g/100 kcal.

As noted, the disclosed nutritional composition may comprise a source of β-glucan. Glucans are polysaccharides, specifically polymers of glucose, which are naturally occurring and may be found in cell walls of bacteria, yeast, fungi, and plants. Beta glucans (β-glucans) are themselves a diverse subset of glucose polymers, which are made up of chains of glucose monomers linked together via beta-type glycosidic bonds to form complex carbohydrates.

β-1,3-glucans are carbohydrate polymers purified from, for example, yeast, mushroom, bacteria, algae, or cereals. (Stone B A, Clarke A E. Chemistry and Biology of (1-3)-Beta-Glucans. London: Portland Press Ltd; 1993.) The chemical structure of β-1,3-glucan depends on the source of the β-1,3-glucan. Moreover, various physiochemical parameters, such as solubility, primary structure, molecular weight, and branching, play a role in biological activities of β-1,3-glucans. (Yadomae T., Structure and biological activities of fungal beta-1,3-glucans. Yakugaku Zasshi. 2000; 120:413-431.)

β-1,3-glucans are naturally occurring polysaccharides, with or without β-1,6-glucose side chains that are found in the cell walls of a variety of plants, yeasts, fungi and bacteria. β-1,3;1,6-glucans are those containing glucose units with (1,3) links having side chains attached at the (1,6) position(s). β-1,3;1,6 glucans are a heterogeneous group of glucose polymers that share structural commonalties, including a backbone of straight chain glucose units linked by a β-1,3 bond with β-1,6-linked glucose branches extending from this backbone. While this is the basic structure for the presently described class of β-glucans, some variations may exist. For example, certain yeast β-glucans have additional regions of β(1,3) branching extending from the β(1,6) branches, which add further complexity to their respective structures.

β-glucans derived from baker's yeast, Saccharomyces cerevisiae, are made up of chains of D-glucose molecules connected at the 1 and 3 positions, having side chains of glucose attached at the 1 and 6 positions. Yeast-derived β-glucan is an insoluble, fiber-like, complex sugar having the general structure of a linear chain of glucose units with a β-1,3 backbone interspersed with β-1,6 side chains that are generally 6-8 glucose units in length. More specifically, β-glucan derived from baker's yeast is poly-(1,6)-β-D-glucopyranosyl-(1,3)-β-D-glucopyranose.

Furthermore, β-glucans are well tolerated and do not produce or cause excess gas, abdominal distension, bloating or diarrhea in pediatric subjects. Addition of β-glucan to a nutritional composition for a pediatric subject, such as an infant formula, a growing-up milk or another children's nutritional product, will improve the subject's immune response by increasing resistance against invading pathogens and therefore maintaining or improving overall health.

The nutritional composition of the present disclosure comprises β-glucan. In some embodiments, the β-glucan is β-1,3;1,6-glucan. In some embodiments, the β-1,3;1,6-glucan is derived from baker's yeast. The nutritional composition may comprise whole glucan particle β-glucan, particulate β-glucan, PGG-glucan (poly-1,6-β-D-glucopyranosyl-1,3-β-D-glucopyranose) or any mixture thereof.

In some embodiments, the amount of β-glucan present in the composition is at between about 0.010 and about 0.080 g per 100 g of composition. In other embodiments, the nutritional composition comprises between about 10 and about 30 mg β-glucan per serving. In another embodiment, the nutritional composition comprises between about 5 and about 30 mg β-glucan per 8 fl. oz. (236.6 mL) serving. In other embodiments, the nutritional composition comprises an amount of β-glucan sufficient to provide between about 15 mg and about 90 mg β-glucan per day. The nutritional composition may be delivered in multiple doses to reach a target amount of β-glucan delivered to the subject throughout the day.

In some embodiments, the amount of β-glucan in the nutritional composition is between about 3 mg and about 17 mg per 100 kcal. In another embodiment the amount of β-glucan is between about 6 mg and about 17 mg per 100 kcal.

The nutritional composition of the present disclosure may comprise lactoferrin. Lactoferrins are single chain polypeptides of about 80 kD containing 1-4 glycans, depending on the species. The 3-D structures of lactoferrin of different species are very similar, but not identical. Each lactoferrin comprises two homologous lobes, called the N- and C-lobes, referring to the N-terminal and C-terminal part of the molecule, respectively. Each lobe further consists of two sub-lobes or domains, which form a cleft where the ferric ion (Fe³⁺) is tightly bound in synergistic cooperation with a (bi)carbonate anion. These domains are called N1, N2, C1 and C2, respectively. The N-terminus of lactoferrin has strong cationic peptide regions that are responsible for a number of important binding characteristics. Lactoferrin has a very high isoelectric point (˜pl 9) and its cationic nature plays a major role in its ability to defend against bacterial, viral, and fungal pathogens. There are several clusters of cationic amino acids residues within the N-terminal region of lactoferrin mediating the biological activities of lactoferrin against a wide range of microorganisms. For instance, the N-terminal residues 1-47 of human lactoferrin (1-48 of bovine lactoferrin) are critical to the iron-independent biological activities of lactoferrin. In human lactoferrin, residues 2 to 5 (RRRR) and 28 to 31 (RKVR) are arginine-rich cationic domains in the N-terminus especially critical to the antimicrobial activities of lactoferrin. A similar region in the N-terminus is found in bovine lactoferrin (residues 17 to 42; FKCRRWQWRMKKLGAPSITCVRRAFA).

Lactoferrins from different host species may vary in their amino acid sequences though commonly possess a relatively high isoelectric point with positively charged amino acids at the end terminal region of the internal lobe. Suitable non-human lactoferrins for use in the present disclosure include, but are not limited to, those having at least 48% homology with the amino acid sequence of human lactoferrin. For instance, bovine lactoferrin (“bLF”) has an amino acid composition which has about 70% sequence homology to that of human lactoferrin. In some embodiments, the non-human lactoferrin has at least 55% homology with human lactoferrin and in some embodiments, at least 65% homology. Non-human lactoferrins acceptable for use in the present disclosure include, without limitation, bLF, porcine lactoferrin, equine lactoferrin, buffalo lactoferrin, goat lactoferrin, murine lactoferrin and camel lactoferrin.

In one embodiment, lactoferrin is present in the nutritional composition in an amount of at least about 15 mg/100 kcal. In certain embodiments, the nutritional composition may include between about 15 and about 300 mg lactoferrin per 100 kcal. In another embodiment, where the nutritional composition is an infant formula, the nutritional composition may comprise lactoferrin in an amount of from about 60 mg to about 150 mg lactoferrin per 100 kcal; in yet another embodiment, the nutritional composition may comprise about 60 mg to about 100 mg lactoferrin per 100 kcal.

In some embodiments, the nutritional composition can include lactoferrin in the quantities of from about 0.5 mg to about 1.5 mg per milliliter of formula. In nutritional compositions replacing human milk, lactoferrin may be present in quantities of from about 0.6 mg to about 1.3 mg per milliliter of formula. In certain embodiments, the nutritional composition may comprise between about 0.1 and about 2 grams lactoferrin per liter. In some embodiments, the nutritional composition includes between about 0.6 and about 1.5 grams lactoferrin per liter of formula.

The bLF that is used in certain embodiments may be any bLF isolated from whole milk and/or having a low somatic cell count, wherein “low somatic cell count” refers to a somatic cell count less than 200,000 cells/mL. By way of example, suitable bLF is available from Tatua Co-operative Dairy Co. Ltd., in Morrinsville, New Zealand, from FrieslandCampina Domo in Amersfoort, Netherlands or from Fonterra Co-Operative Group Limited in Auckland, New Zealand.

Lactoferrin for use in the present disclosure may be, for example, isolated from the milk of a non-human animal or produced by a genetically modified organism. For example, in U.S. Pat. No. 4,791,193, incorporated by reference herein in its entirety, Okonogi et al. discloses a process for producing bovine lactoferrin in high purity. Generally, the process as disclosed includes three steps. Raw milk material is first contacted with a weakly acidic cationic exchanger to absorb lactoferrin followed by the second step where washing takes place to remove nonabsorbed substances. A desorbing step follows where lactoferrin is removed to produce purified bovine lactoferrin. Other methods may include steps as described in U.S. Pat. Nos. 7,368,141, 5,849,885, 5,919,913 and 5,861,491, the disclosures of which are all incorporated by reference in their entirety.

In certain embodiments, lactoferrin utilized in the present disclosure may be provided by an expanded bed absorption (“EBA”) process for isolating proteins from milk sources. EBA, also sometimes called stabilized fluid bed adsorption, is a process for isolating a milk protein, such as lactoferrin, from a milk source comprises establishing an expanded bed adsorption column comprising a particulate matrix, applying a milk source to the matrix, and eluting the lactoferrin from the matrix with an elution buffer comprising about 0.3 to about 2.0 M sodium chloride. Any mammalian milk source may be used in the present processes, although in particular embodiments, the milk source is a bovine milk source. The milk source comprises, in some embodiments, whole milk, reduced fat milk, skim milk, whey, casein, or mixtures thereof.

In particular embodiments, the target protein is lactoferrin, though other milk proteins, such as lactoperoxidases or lactalbumins, also may be isolated. In some embodiments, the process comprises the steps of establishing an expanded bed adsorption column comprising a particulate matrix, applying a milk source to the matrix, and eluting the lactoferrin from the matrix with about 0.3 to about 2.0M sodium chloride. In other embodiments, the lactoferrin is eluted with about 0.5 to about 1.0 M sodium chloride, while in further embodiments, the lactoferrin is eluted with about 0.7 to about 0.9 M sodium chloride.

The expanded bed adsorption column can be any known in the art, such as those described in U.S. Pat. Nos. 7,812,138, 6,620,326, and 6,977,046, the disclosures of which are hereby incorporated by reference herein. In some embodiments, a milk source is applied to the column in an expanded mode, and the elution is performed in either expanded or packed mode. In particular embodiments, the elution is performed in an expanded mode. For example, the expansion ratio in the expanded mode may be about 1 to about 3, or about 1.3 to about 1.7. EBA technology is further described in international published application nos. WO 92/00799, WO 02/18237, WO 97/17132, which are hereby incorporated by reference in their entireties.

The isoelectric point of lactoferrin is approximately 8.9. Prior EBA methods of isolating lactoferrin use 200 mM sodium hydroxide as an elution buffer. Thus, the pH of the system rises to over 12, and the structure and bioactivity of lactoferrin may be comprised, by irreversible structural changes. It has now been discovered that a sodium chloride solution can be used as an elution buffer in the isolation of lactoferrin from the EBA matrix. In certain embodiments, the sodium chloride has a concentration of about 0.3 M to about 2.0 M. In other embodiments, the lactoferrin elution buffer has a sodium chloride concentration of about 0.3 M to about 1.5 M, or about 0.5 m to about 1.0 M.

One or more vitamins and/or minerals may also be added in to the nutritional composition in amounts sufficient to supply the daily nutritional requirements of a subject. It is to be understood by one of ordinary skill in the art that vitamin and mineral requirements will vary, for example, based on the age of the child. For instance, an infant may have different vitamin and mineral requirements than a child between the ages of one and thirteen years. Thus, the embodiments are not intended to limit the nutritional composition to a particular age group but, rather, to provide a range of acceptable vitamin and mineral components.

In embodiments providing a nutritional composition for a child, the composition may optionally include, but is not limited to, one or more of the following vitamins or derivations thereof: vitamin B₁ (thiamin, thiamin pyrophosphate, TPP, thiamin triphosphate, TTP, thiamin hydrochloride, thiamin mononitrate), vitamin B₂ (riboflavin, flavin mononucleotide, FMN, flavin adenine dinucleotide, FAD, lactoflavin, ovoflavin), vitamin B₃ (niacin, nicotinic acid, nicotinamide, niacinamide, nicotinamide adenine dinucleotide, NAD, nicotinic acid mononucleotide, NicMN, pyridine-3-carboxylic acid), vitamin B₃-precursor tryptophan, vitamin B₆ (pyridoxine, pyridoxal, pyridoxamine, pyridoxine hydrochloride), pantothenic acid (pantothenate, panthenol), folate (folic acid, folacin, pteroylglutamic acid), vitamin B₁₂ (cobalamin, methylcobalamin, deoxyadenosylcobalamin, cyanocobalamin, hydroxycobalamin, adenosylcobalamin), biotin, vitamin C (ascorbic acid), vitamin A (retinol, retinyl acetate, retinyl palmitate, retinyl esters with other long-chain fatty acids, retinal, retinoic acid, retinol esters), vitamin D (calciferol, cholecalciferol, vitamin D₃, 1,25,-dihydroxyvitamin D), vitamin E (α-tocopherol, α-tocopherol acetate, α-tocopherol succinate, α-tocopherol nicotinate, α-tocopherol), vitamin K (vitamin K₁, phylloquinone, naphthoquinone, vitamin K₂, menaquinone-7, vitamin K₃, menaquinone-4, menadione, menaquinone-8, menaquinone-8H, menaquinone-9, menaquinone-9H, menaquinone-10, menaquinone-11, menaquinone-12, menaquinone-13), choline, inositol, β-carotene and any combinations thereof.

In embodiments providing a children's nutritional product, such as a growing-up milk, the composition may optionally include, but is not limited to, one or more of the following minerals or derivations thereof: boron, calcium, calcium acetate, calcium gluconate, calcium chloride, calcium lactate, calcium phosphate, calcium sulfate, chloride, chromium, chromium chloride, chromium picolonate, copper, copper sulfate, copper gluconate, cupric sulfate, fluoride, iron, carbonyl iron, ferric iron, ferrous fumarate, ferric orthophosphate, iron trituration, polysaccharide iron, iodide, iodine, magnesium, magnesium carbonate, magnesium hydroxide, magnesium oxide, magnesium stearate, magnesium sulfate, manganese, molybdenum, phosphorus, potassium, potassium phosphate, potassium iodide, potassium chloride, potassium acetate, selenium, sulfur, sodium, docusate sodium, sodium chloride, sodium selenate, sodium molybdate, zinc, zinc oxide, zinc sulfate and mixtures thereof. Non-limiting exemplary derivatives of mineral compounds include salts, alkaline salts, esters and chelates of any mineral compound.

The minerals can be added to growing-up milks or to other children's nutritional compositions in the form of salts such as calcium glycerol phosphate, sodium citrate, magnesium phosphate, ferrous sulfate, cupric sulfate, manganese sulfate, and sodium selenite. Additional vitamins and minerals can be added as known within the art.

The disclosed nutritional composition may comprise a source of iron. The iron may comprise encapsulated iron forms, such as encapsulated ferrous fumarate or encapsulated ferrous sulfate or less reactive iron forms, such as ferric pyrophosphate or ferric orthophosphate.

The nutritional compositions of the present disclosure may optionally include one or more of the following flavoring agents, including, but not limited to, flavored extracts, volatile oils, cocoa or chocolate flavorings, peanut butter flavoring, cookie crumbs, vanilla or any commercially available flavoring. Examples of useful flavorings include, but are not limited to, pure anise extract, imitation banana extract, imitation cherry extract, chocolate extract, pure lemon extract, pure orange extract, pure peppermint extract, honey, imitation pineapple extract, imitation rum extract, imitation strawberry extract, or vanilla extract; or volatile oils, such as balm oil, bay oil, bergamot oil, cedarwood oil, cherry oil, cinnamon oil, clove oil, or peppermint oil; peanut butter, chocolate flavoring, vanilla cookie crumb, butterscotch, toffee, and mixtures thereof. The amounts of flavoring agent can vary greatly depending upon the flavoring agent used. The type and amount of flavoring agent can be selected as is known in the art.

The nutritional compositions of the present disclosure may optionally include one or more preservatives that may also be added to extend product shelf life. Suitable preservatives include, but are not limited to, potassium sorbate, sodium sorbate, potassium benzoate, sodium benzoate, calcium disodium EDTA, and mixtures thereof.

The nutritional compositions of the present disclosure may optionally include one or more stabilizers. Suitable stabilizers for use in practicing the nutritional composition of the present disclosure include, but are not limited to, gum arabic, gum ghatti, gum karaya, gum tragacanth, agar, furcellaran, guar gum, gellan gum, locust bean gum, pectin, low methoxyl pectin, gelatin, microcrystalline cellulose, CMC (sodium carboxymethylcellulose), methylcellulose hydroxypropyl methyl cellulose, hydroxypropyl cellulose, DATEM (diacetyl tartaric acid esters of mono- and diglycerides), dextran, carrageenans, and mixtures thereof.

In some embodiments the nutritional composition is an infant formula. Infant formulas are fortified nutritional compositions for an infant. The content of an infant formula is dictated by federal regulations, which define macronutrient, vitamin, mineral, and other ingredient levels in an effort to simulate the nutritional and other properties of human breast milk. Infant formulas are designed to support overall health and development in a pediatric human subject, such as an infant or a child.

In other embodiments, the nutritional composition of the present disclosure is a growing-up milk. Growing-up milks are fortified milk-based beverages intended for children over 1 year of age (typically from 1-3 years of age, from 4-6 years of age or from 1-6 years of age). They are not medical foods and are not intended as a meal replacement or a supplement to address a particular nutritional deficiency. Instead, growing-up milks are designed with the intent to serve as a complement to a diverse diet to provide additional insurance that a child achieves continual, daily intake of all essential vitamins and minerals, macronutrients plus additional functional dietary components, such as non-essential nutrients that have purported health-promoting properties.

The disclosed nutritional composition(s) may be provided in any form known in the art, such as a powder, a gel, a suspension, a paste, a solid, a tablet, a liquid, a liquid concentrate, a reconstituteable powdered milk substitute or a ready-to-use product. The nutritional composition may, in certain embodiments, comprise a nutritional supplement, children's nutritional product, infant formula, human milk fortifier, growing-up milk or any other nutritional composition designed for an infant or a pediatric subject. Nutritional compositions of the present disclosure include, for example, orally-ingestible, health-promoting substances including, for example, foods, beverages, tablets, capsules and powders. Moreover, the nutritional composition of the present disclosure may be standardized to a specific caloric content, it may be provided as a ready-to-use product, or it may be provided in a concentrated form. In some embodiments, the nutritional composition is in powder form with a particle size in the range of 5 μm to 1500 μm, more preferably in the range of 10 μm to 300 μm.

The exact composition of an infant formula or other nutritional composition according to the present disclosure can vary from market-to-market, depending on local regulations and dietary intake information of the population of interest. In some embodiments, nutritional compositions according to the disclosure consist of a rice protein hydrolysate protein equivalent source, plus added sugar and sweeteners to achieve desired sensory properties, and added vitamins and minerals. The fat composition includes an enriched lipid fraction derived from milk. Total carbohydrate is usually targeted to provide as little added sugar, such as sucrose or fructose, as possible to achieve an acceptable taste. Typically, Vitamin A, calcium and Vitamin D are added at levels to match the nutrient contribution of regional cow milk. Otherwise, in some embodiments, vitamins and minerals can be added at levels that provide approximately 20% of the dietary reference intake (DRI) or 20% of the Daily Value (DV) per serving. Moreover, nutrient values can vary between markets depending on the identified nutritional needs of the intended population, raw material contributions and regional regulations.

The nutritional compositions of the disclosure may provide minimal, partial, or total nutritional support. The compositions may be nutritional supplements or meal replacements. The compositions may, but need not, be nutritionally complete. In an embodiment, the nutritional composition of the disclosure is nutritionally complete and contains suitable types and amounts of lipid, carbohydrate, protein, vitamins and minerals.

In an embodiment, the children's nutritional composition may contain between about 10 and about 50% of the maximum dietary recommendation for any given country, or between about 10 and about 50% of the average dietary recommendation for a group of countries, per serving of vitamins A, C, and E, zinc, iron, iodine, selenium, and choline. In another embodiment, the children's nutritional composition may supply about 10-30% of the maximum dietary recommendation for any given country, or about 10-30% of the average dietary recommendation for a group of countries, per serving of B-vitamins. In yet another embodiment, the levels of vitamin D, calcium, magnesium, phosphorus, and potassium in the children's nutritional product may correspond with the average levels found in milk. In other embodiments, other nutrients in the children's nutritional composition may be present at about 20% of the maximum dietary recommendation for any given country, or about 20% of the average dietary recommendation for a group of countries, per serving.

Further, the present disclosure is directed to methods of producing a rice protein hydrolysate comprising the steps of suspending rice protein in water, heating the suspension, cooling the suspension, adding an endoprotease to the suspension to hydrolyze the rice protein into at least two supernatant fractions, inactivating the endoprotease, separating an insoluble portion of the suspension from the at least two supernatant fractions, collecting the at least two supernatant fractions; and combining the at least two supernatant fractions. The “supernatant fraction” may also be referred to as a “supernatant permeate.” The combined at least two supernatant fractions may be the rice protein hydrolysate disclosed herein. The benefits of the disclosed methods of producing rice protein hydrolysate include a well-controlled hydrolysis process, low cost of production, a resulting rice protein hydrolysate with improved neutral pH solubility and digestibility. Further, the benefits of the disclosed methods may include a rice protein hydrolysate with reduced amounts of manganese, selenium, aluminum and phytic acid.

In an embodiment, the method of producing a rice protein hydrolysate includes adding only one endoprotease to the suspension to hydrolyze the rice protein into at least two supernatant fractions. The endoprotease may be added, for example, after the pH of the suspension is adjusted to from 7.5 to 8.5. The endoprotease may be, for example, 2% Amano Protease N enzyme. The pH of the suspension may be maintained at from 7.5 to 8.5 for 2 hours to 6 hours, preferably 4 hours. The pH of the suspension may be maintained with a base, for example, sodium hydroxide solution of a 10% concentration by weight. In another embodiment, the pH may be adjusted to 7.5 to 8.5, maintained for 30 minutes to 90 minutes and not adjusted for a subsequent 2 hours to 4 hours or through the remaining duration of the hydrolysis.

In another embodiment, the endoprotease may be from the group of bacillolysins and/or subtilysins obtained from Bacillus subtilis (International Union of Biochemistry Enzyme Commission Number 3.4.24.28) and Bacillus amyloliquefaciens (International Union of Biochemistry Enzyme Commission Number 3.4.21.62). The enzymes extracted from these strains are generally recognized as safe for use as direct food ingredients, including, for example, confirming to GRAS, FAO, WHO, FCC, and FDA approval. These enzymes may also be non-GMO, Kosher and Halal. Commercially available versions of these enzymes include, for example, Protease N (Amano Enzyme Inc.), Bioprotease 900NP (Kerry Ingredients & Flavours), Neutrase (Novozymes) and Enzeco Neutral Bacterial Protease BA 70 (Enzyme Development Corporation). The disclosure herein also applies to compositions with various levels of total protein. Furthermore, some enzymes such as trypsin and/or chymotrypsin generally sourced from animal organ pancreas, could be also produced from genetically modified strain, which could be applied to this hydrolysis process.

In an embodiment, a method of producing rice protein hydrolysate may include adding an exoprotease. In another embodiment, a method of producing rice protein hydrolysate may include adding a peptidase. Examples of exoproteases and peptidases, include, for example, Flavozyme (Novozymes), ProteaAX (Amano), and/or Pancreatin from procine pancreas.

In a further embodiment, a method of producing rice protein hydrolysate may include heating the suspension to from about 70° C. to about 90° C. for between 5 minutes and 15 minutes. Preferably, the suspension is heated to about 80° C. for about 10 minutes.

In an embodiment, a method of producing rice protein hydrolysate may include cooling the suspension to from about 45° C. to about 65° C. The cooling of the suspension may occur after the suspension is heated. In another embodiment, the pH of the suspension may be adjusted. For example, the pH of the solution may be adjusted to from 7.5 to 8.5, preferably 8.0. The pH may be adjusted with a base, for example, sodium hydroxide solution of a 10% concentration by weight. The pH adjustment may occur after the cooling of the suspension. The pH adjustment may occur before the endoprotease is added. The pH may be adjusted so that the endoprotease has a higher activity level. Further, the suspension may be cooled before its pH is adjusted.

In some embodiments, the pH of the suspension may be adjusted from 6.5 to 7.0, preferably 6.7 subsequently to adding the endoprotease. The subsequent adjustment of pH of the suspension may occur after the adjustment to or maintenance of the pH from 7.5 to 8.5. The pH may be subsequently adjusted with an acid, such as a phosphoric acid solution. In another embodiment, a subsequent adjustment of the pH of the suspension is optional.

In an embodiment, a method of producing rice protein hydrolysate may include separating the insoluble portion of the suspension to form supernatant fractions. Separation may occur by centrifugation, filter press, and/or separation techniques known in the art. Centrifugation, for example, may be at 5000 rpm for 30 minutes. The filter press may, for example, include mixing the suspension with filter aids.

In another embodiment, the supernatant may be purified by filtration. Purification may occur, for example, before or after the supernatant fractions are combined and may be by ultrafiltration. Ultrafiltration may remove potential rice allergenic proteins with a molecular weight of from 14 to 16 KDa, a salt soluble fraction. The ultrafiltration may use a membrane of from 5000 MWCO to 10,000 MWCO to remove undesired large molecules and/or impurities from the supernatant fractions.

In an embodiment, a method of producing rice protein hydrolysate may include drying the supernatant fractions. The drying may occur, for example, before or after the supernatant fractions are combined. The supernatant fractions may be dried by spray drying.

In some embodiments, the insoluble portion may be washed with distilled water. In an embodiment, the separating of the insoluble portion may be by a wash process. The amount of distilled water may be, for example, half of the suspension volume. In another embodiment, the amount of distilled water may be half of the volume of the endoprotease amount that is added to the suspension. The supernatant fraction may be water soluble. The supernatant fraction may have a large portion of small peptides (molecular weight less than 2000 Daltons) and a small proportion of free amino acids.

In an embodiment, the endoprotease may be inactivated by heating the suspension to from about 80° C. to about 95° C. for about 5 minutes to 15 minutes.

In an alternate embodiment, a method of producing rice protein hydrolysate may include suspending rice protein in a solution to form a suspension. The solution may be water and include a solids content of 10% by weight. The rice protein may be from a commercially available source, including rice protein concentrate or rice protein isolate. A rice protein isolate may include a rice protein content of greater than 70% by weight. The rice protein may be a digestion substrate. The rice protein may be from a brown rice or a milled rice source, preferably a milled rice source. The rice protein may be suspended in a solution to form a slurry.

The PER value of the presently disclosed rice protein hydrolysate(s) is improved over commercial formula samples. Table 1 lists PER values and Relative PER values for the nutritional composition of the present disclosure as compared to a control group (Animal Nutrition Research Council (ANRC) Casein) and commercially available rice hydrolysate based nutritional formulas that are not supplemented with lysine, threonine, methionine or tryptophan.

TABLE 1
PER value and Relative PER value of present disclosure
compared to control group and commercial formulas.

| Ingredient | PER Value | Relative PER Value |
|---|---|---|
| Rice protein hydrolysate based | 2.8 | 97% |
| formula supplemented with | | |
| lysine, threonine, methionine and | | |
| tryptophan | | |
| Rice protein hydrolysate based | 1.9 | 66% |
| formula supplemented with | | |
| lysine, threonine and tryptophan. | | |
| Commercially available rice | 1.8 | 62% |
| protein hydrolysate based | | |
| formula not supplemented with | | |
| lysine, threonine, methionine or | | |
| tryptophan (Formula A) | | |
| Commercially available rice | 1.4 | 48% |
| protein hydrolysate based | | |
| formula not supplemented with | | |
| lysine, threonine, methionine or | | |
| tryptophan (Formula B) | | |
| ANRC Casein (control group) | 2.9 | 100% |

Thus, the nutritional compositions of the present disclosure have superior PER values (2.8 and 1.9) over commercially available rice protein hydrolysate based formulas (1.8 and 1.4). Indeed, where the rice protein hydrolysate is supplemented with lysine, threonine, methionine and tryptophan, the relative PER value is statistically indistinguishable from the ANRC Casein control group.

### Formulation Example

Table 2 provides an example embodiment of the nutritional profile of a rice protein hydrolysate based formula that includes a rice protein hydrolysate with OSA modified starch as described herein.

TABLE 2
Formulation of a rice protein
hydrolysate based formula

| Ingredient | Amount per 100 g | |
|---|---|---|
| Maltodextrin | 46.7 | g |
| Fat blend | 25.4 | g |
| Rice protein hydrolysate | 17 | g |
| Octenyl succinic anhydride | 5 | g |
| modified starch | | |
| Calcium phosphate | 1.3 | g |
| Calcium citrate | 0.9 | g |
| Potassium citrate | 0.8 | g |
| ARA and DHA | 0.7 | g |
| Sodium citrate | 0.2 | g |
| Choline chloride | 0.2 | g |
| Potassium chloride | 0.1 | g |
| Magnesium oxide | 0.07 | g |
| Calcium hydroxide | 0.06 | g |
| L-carnitine | 0.01 | g |
| Sodium iodide | 0.1 | mg |
| Vitamin, taurine and | 1.2 | g |
| methionine mix | | |
| Iron trituration | 0.2 | g |
| Trace/ultratrace minerals | 0.12 | g |

Accordingly, by the practice of the present disclosure, rice protein hydrolysate based nutritional formulations having a high PER value are prepared. Particularly, the rice protein hydrolysate based nutritional formulation of the present invention are supplemented with lysine, threonine, methionine, tryptophan, and combinations thereof. The rice hydrolysate based nutritional formulations of the present disclosure have improved digestibility, solubility and physical properties. Moreover, octenyl succinic anhydride modified starch may be included in the nutritional formulations to create a stabilized, emulsified, and antiallergenic formulation.

What is claimed is:

1. A nutritional composition comprising:
a protein equivalent source comprising a rice protein hydrolysate;
a carbohydrate;
a fat or lipid; and
an emulsifier comprising an octenyl succinic anhydride modified starch.

2. The nutritional composition of claim 1, wherein at least about 20% of the rice protein hydrolysate has a molecular weight of from 1000 to 1999 Daltons, and at least about 1% of the rice protein hydrolysate has a molecular weight of from 2000 to 2999 Daltons.

3. The nutritional composition of claim 1, wherein:
the rice protein hydrolysate has a degree of hydrolysis in the range of from about 10% to about 35%.

4. The nutritional composition of claim 1, wherein:
the octenyl succinic anhydride modified starch is from about 0.01% to about 20% by weight of the nutritional composition.

5. The nutritional composition of claim 1, wherein:
the octenyl succinic anhydride modified starch is derived from a source having greater than about 95% amylopectin by weight.

6. The nutritional composition of claim 1, wherein the protein equivalent source further comprises at least one free amino acid selected from the group consisting of lysine, threonine, methionine, and tryptophan.

7. The nutritional composition of claim 1, further comprising at least one long chain polyunsaturated fatty acid, wherein the at least one long chain polyunsaturated fatty acid comprises docosahexaenoic acid, arachidonic acid, or a combination thereof.

8. The nutritional composition of claim 1, further comprising at least one prebiotic comprising polydextrose, galactooligosaccharide or combinations thereof.

9. A method of producing rice protein hydrolysate, comprising:
suspending rice protein in a solution to form a suspension;
heating the suspension;
cooling the heated suspension;
adding an endoprotease to the suspension to hydrolyze the rice protein into at least two supernatant fractions;
inactivating the endoprotease;
separating an insoluble portion of the suspension from the at least two supernatant fractions;
collecting the at least two supernatant fractions; and
combining the at least two supernatant fractions.

10. The method of claim 9, wherein the adding an endoprotease is adding one endoprotease.

11. The method of claim 9, further comprising purifying the supernatant fractions.

12. The method of claim 9, further comprising drying the at least two supernatant fractions.

13. The method of claim 9, further comprising using the at least two supernatant fractions as a protein source in the preparation of a nutritional formulation.

14. The method of claim 9, further comprising adding an exoprotease.

15. The method of claim 9, further comprising adding a peptidase.

16. The method of claim 9, wherein the endoprotease is bacillolysins or subtilysins obtained from Bacillus subtilis or Bacillus amyloliquefaciens.

17. A method for providing complete nutrition to an infant having cow's milk protein allergy, comprising
administering to an infant a nutritionally-complete composition comprising
a protein equivalent source comprising a rice protein hydrolysate;
a carbohydrate;
a fat or lipid; and
an emulsifier comprising an octenyl succinic anhydride modified starch,
wherein the rice protein hydrolysate has a degree of hydrolysis in the range of from about 10% to about 35%.

18. The method of claim 17, wherein at least about 20% of the rice protein hydrolysate has a molecular weight of from 1000 to 1999 Daltons, and at least about 1% of the rice protein hydrolysate has a molecular weight of from 2000 to 2999 Daltons.

19. The method of claim 17, wherein the nutritionally-complete composition has a octenyl succinic anhydride modified starch to lipid ratio of from about 1:1 to about 1:8.

20. The method of claim 17, wherein the protein equivalent source further comprises at least one free amino acid selected from the group consisting of lysine, threonine, methionine, and tryptophan.
